(19) United States
(12) Patent Application Publication
(10) Pub. No.: US 2016/0036881 A1
(43) Pub. Date: Feb. 4, 2016

(54) COMPUTING DEVICE AND METHOD FOR EXCHANGING METADATA WITH PEER DEVICES IN ORDER TO OBTAIN MEDIA PLAYBACK RESOURCES FROM A NETWORK SERVICE

(71) Applicant: QUALCOMM Incorporated, San Diego, CA (US)

(72) Inventors: Priyanka M. Tembey, Mountain View, CA (US); Vrajesh R. Bhavsar, Sunnyvale, CA (US); Saumitra Mohan Das, Santa Clara, CA (US); Dilma M. Da Silva, Mountain View, CA (US)

(21) Appl. No.: 14/450,098

(22) Filed: Aug. 1, 2014

(51) Int. Cl. H04L 29/06

(52) U.S. Cl. CPC H04L 65/601; H04L 65/4069

(57) ABSTRACT

A computing device operates to receive, from at least a first peer device, a set of metadata that includes one or more identifiers to media playback resources. The computing device operates to determine one or more filters for the set of metadata. A metadata from the set of metadata is selected based on the one or more filters. A search request is provided to a network service for a media playback resource based on the selected metadata.

### BACKGROUND

Media playback is an important use for many types of computing devices, including mobile computing devices such as messaging/telephony devices. Media such as song or videos can be stored in the memory of the computing devices or accessed by the computing device from a variety of network services. Streaming services, in particular, are popular, but require bandwidth and other network resources from the individual computing devices for optimal access.

### BRIEF DESCRIPTION OF THE DRAWINGS

FIG. 1 illustrates an example system for enabling sharing and use of metadata in connection with network services that provide media playback resources.

FIG. 2 illustrates an example of a sharing device, according to an aspect.

FIG. 3 illustrates an example of a receiving device, according to an aspect.

FIG. 4 illustrates an example of a metadata receiving and sharing device.

FIG. 5 illustrates an example of a filtering component.

FIG. 6 illustrates an example method for sharing metadata related to the media playback resources.

FIG. 7 illustrates an example method for receiving metadata from other peer devices and using the metadata to discover media playback resources.

FIG. 8 illustrates an example method for receiving metadata from other peer devices, and for forwarding received metadata to other devices for use.

FIG. 9 is a block diagram that illustrates a computer system upon which embodiments described herein may be implemented.

### DETAILED DESCRIPTION

Examples described herein provide for a computing device that operates to acquire metadata from another device, and further uses the metadata to discover media resources from a network service.

In one implementation, a computing device operates to receive, from at least a first peer device, a set of metadata that includes one or more identifiers to media playback resources. The computing device operates to determine one or more filters for the set of metadata. A metadata from the set of metadata is selected based on the one or more filters. A search request is provided to a network service for a media playback resource based on the selected metadata.

According to another aspect, a computer system is provided that includes a first computing device that shares metadata and a second computing device that receives and utilizes the metadata. The first device operates to receive

A media playback resource from a first network service, and extracts metadata, including a first set of metadata, from the media playback resource. The first device broadcasts data corresponding to the first set of metadata. The second device operates to aggregate metadata from a plurality of sources, including metadata from the first set of metadata. Additionally, the second device operates to determine one or more filters, and to select metadata from the aggregated metadata based on the one or more filters. The second device sends a search request to one of the first network service or a second network service.

Among other benefits, examples as described herein allow for users to share and for discover media from other users in a social setting. The data that is communicated to enable sharing and/or discovering can include metadata, which enables the data exchanges to be limited in size. Among other benefits, such embodiments enable the individual users to preserve bandwidth, and also to conserve the amount of data that is transmitted or received on individual wireless devices (e.g., thus limiting amount of data used under cellular data plan), while permitting the individual user to share or discover media. Additionally, embodiments enable individuals to utilize a more diverse and/or locationally relevant source (e.g., other individuals with similar interests) for discovering media.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

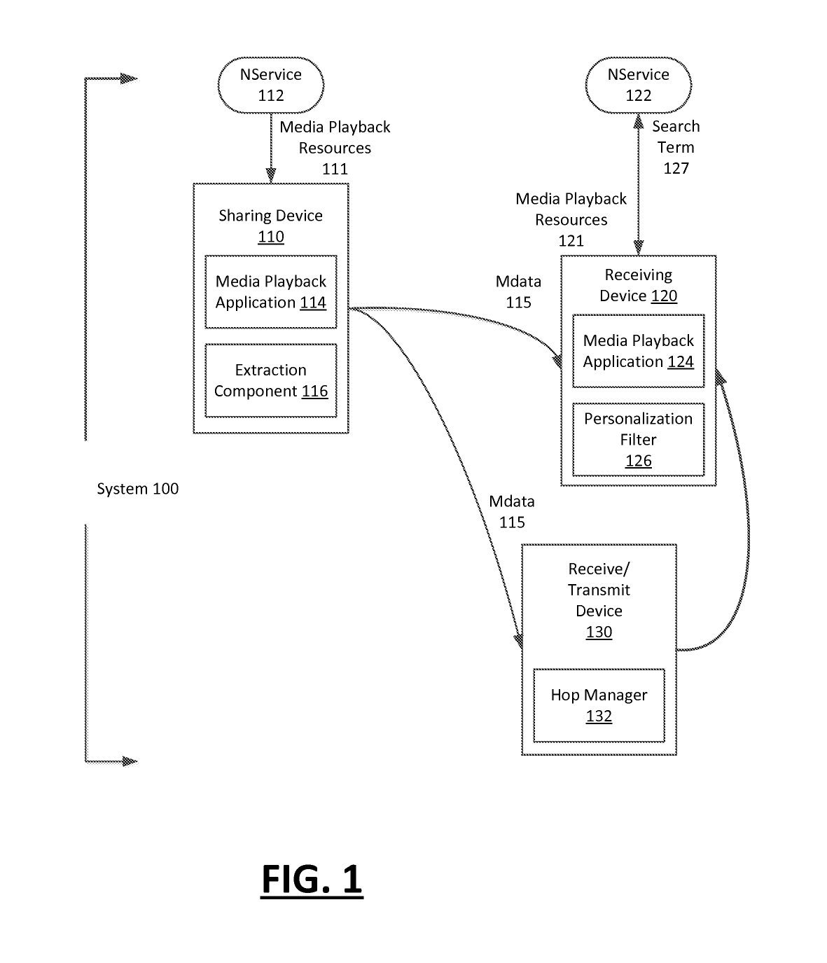

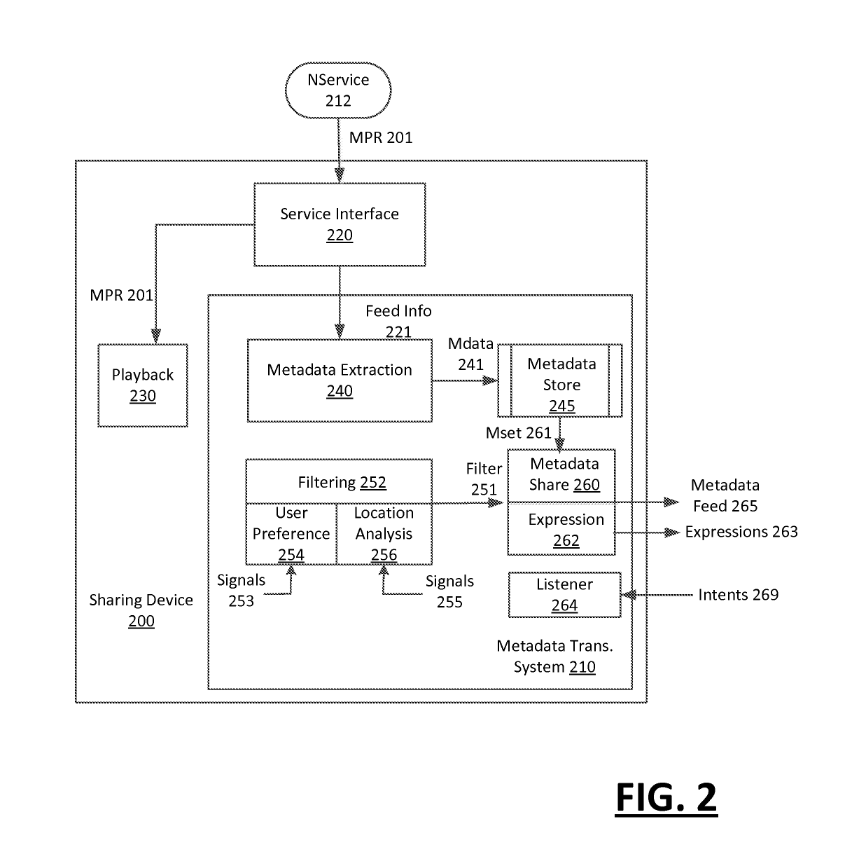

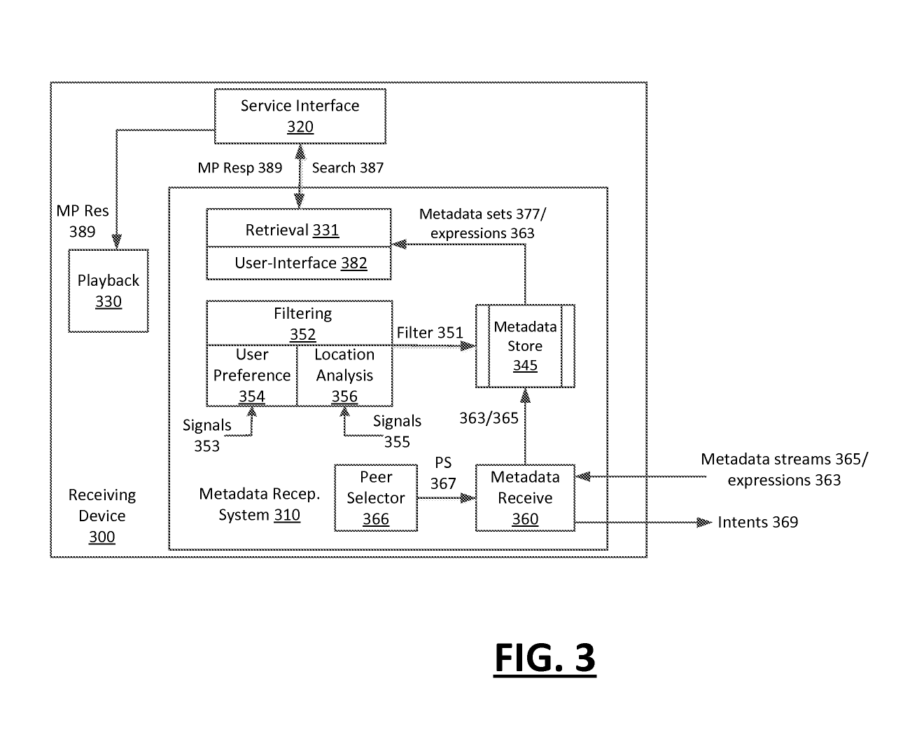

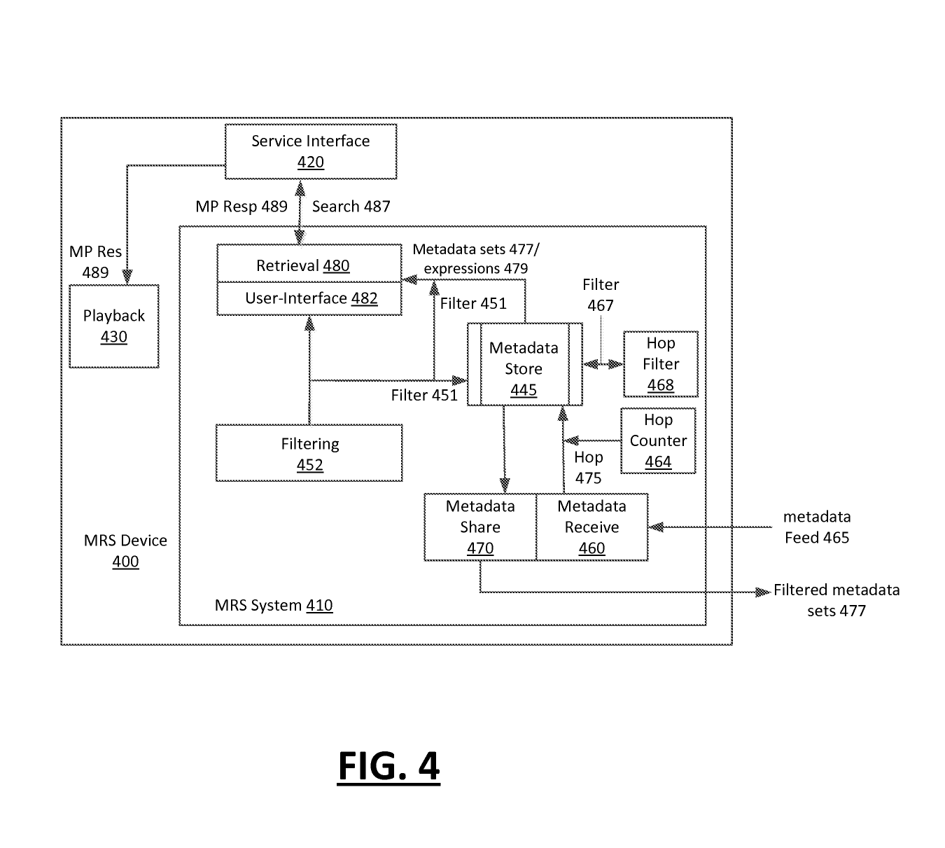

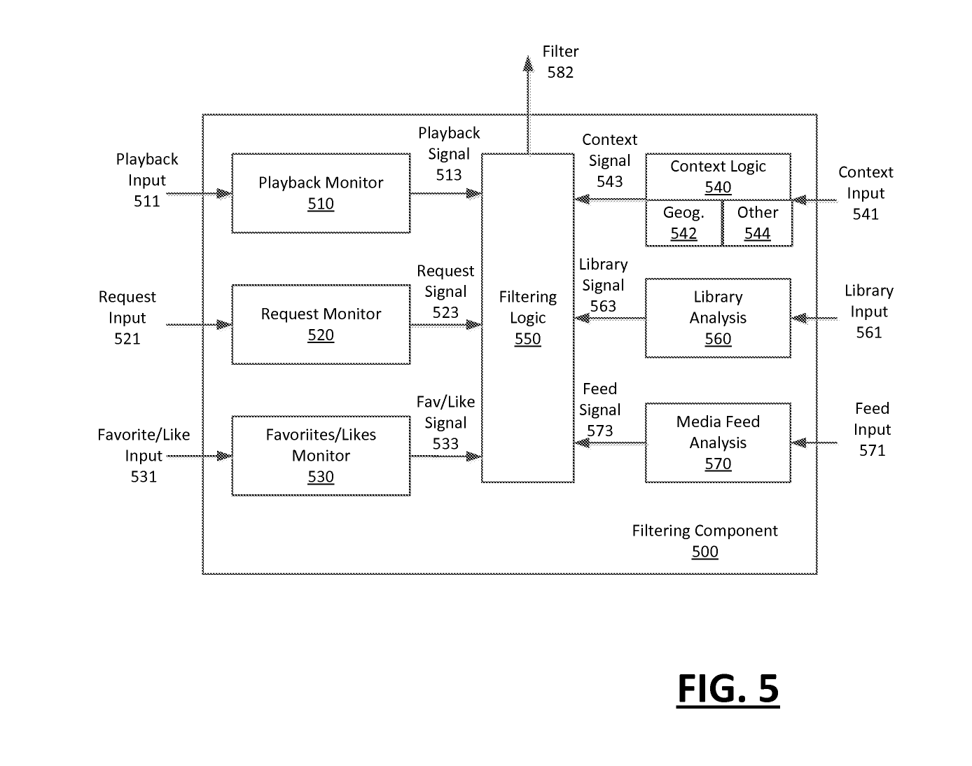

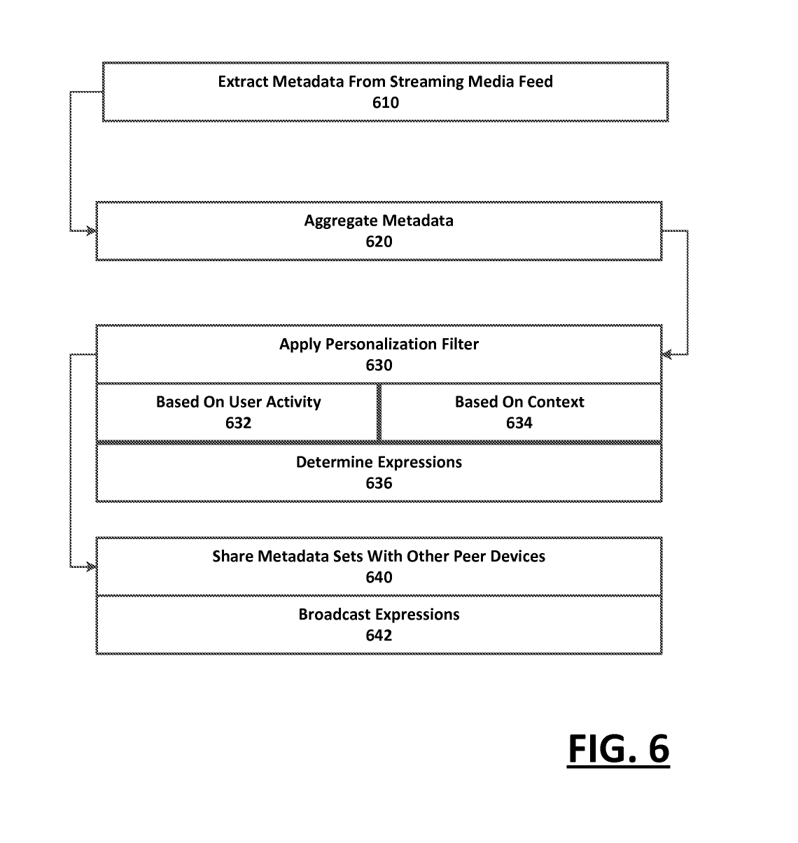

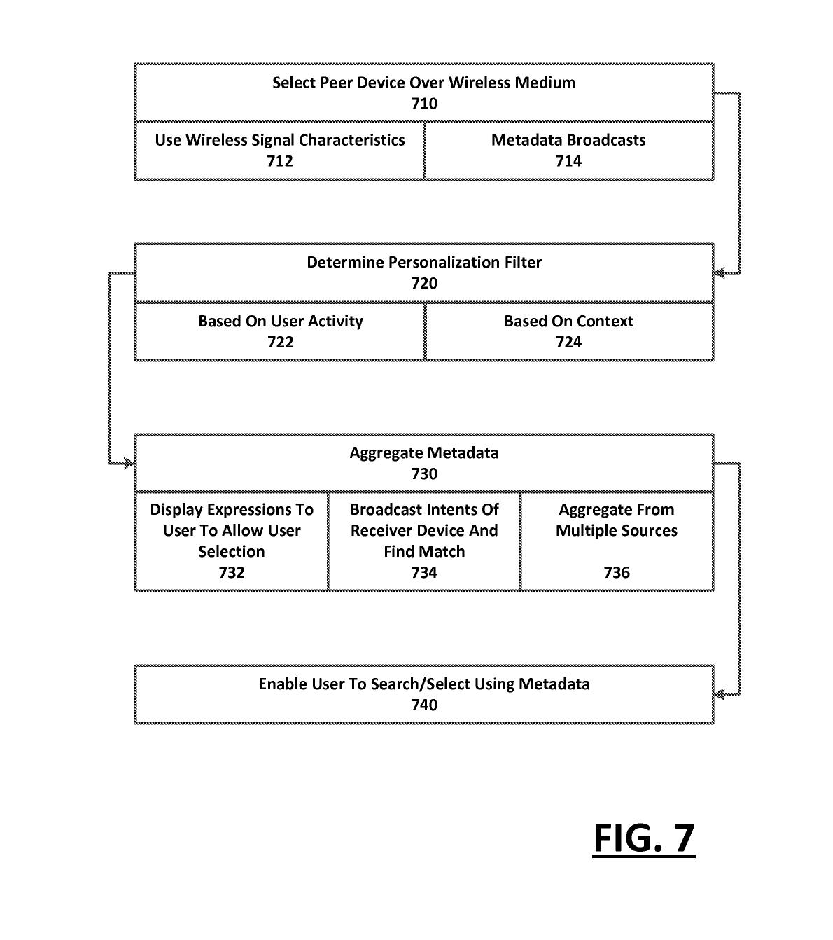

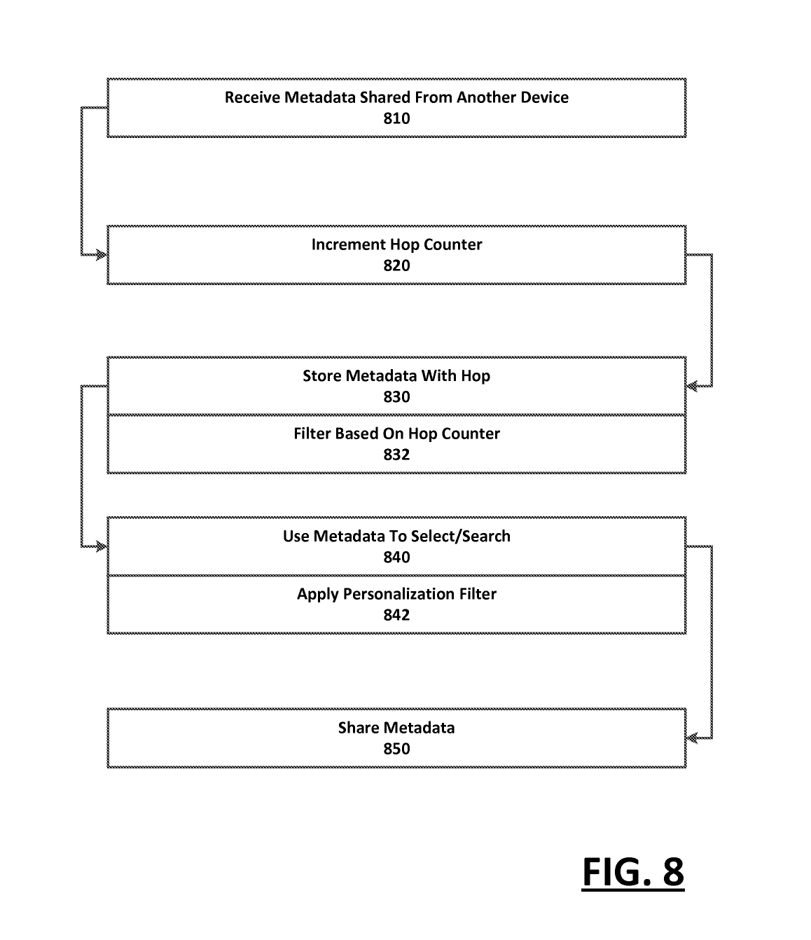

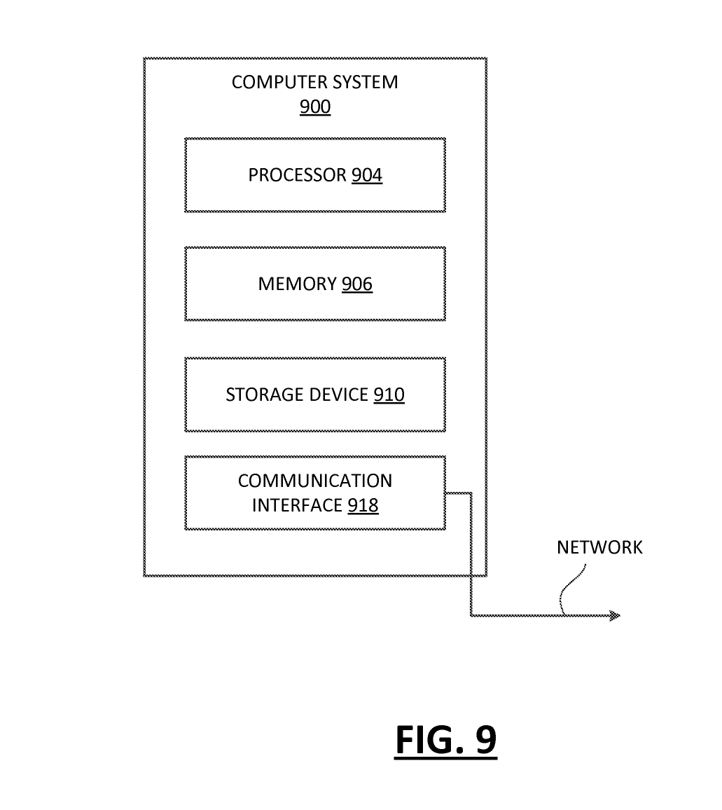

FIG. 1 illustrates an example system for enabling sharing and use of metadata in connection with network services that provide media playback resources. FIG. 2 illustrates an example of a sharing device, according to an aspect. FIG. 3 illustrates an example of a receiving device, according to an aspect. FIG. 4 illustrates an example of a metadata receiving and sharing device (“MRS device 400”). FIG. 5 illustrates an example of a filtering component. FIG. 6 illustrates an example method for sharing metadata related to the media playback resources. FIG. 7 illustrates an example method for receiving metadata from other peer devices and using the metadata to discover media playback resources. FIG. 8 illustrates an example method for receiving metadata from other peer devices, and for forwarding received metadata to other devices for use. FIG. 9 is a block diagram that illustrates a computer system upon which embodiments described herein may be implemented. According to one aspect, system 100 can be implemented in the context of a public setting, such as at a restaurant or coffee shop or other public venue where individuals access network services and consume media playback resources such as music. Devices of system 100 can be interconnected to one another using a local wireless peer connection, such as provided by Wi-Fi Direct or LTE.

The system 100 can include a sharing device 110 and one or more receiving devices 120. In some implementations, each of the sharing device 110 and receiving device 120 can correspond to a mobile computing device, such as a cellular telephony-messaging device or tablet device. The sharing device 110 and receiving device 120 can, in some variations, operate different computing platforms, but share a platform that enables the exchange of metadata for use in identifying media playback resources provided at different network services. By way of example, each of the sharing and receiving devices 110, 120 can operate an application that enables each of the respective mobile computing devices to (i) operate as either the sharing device 110, receiving device 120, or intermediate device (MRS device 130), and (ii) communicate with one another in the respective roles as sharing and/or receiving device 110, 120.

In more detail, sharing device 110 communicates with the first network service 112 in order to receive media playback resources 111. By way of example, media playback resources 111 can correspond to streaming music titles, and the first network service 112 can correspond to, for example, a streaming service such as SPOTIFY, BEATS MUSIC, PANDORA, or GOOGLE PLAY. As another example or variation, the media playback resources 111 can correspond to locally stored media files on the sharing device. In the former example, the sharing device 110 can include a media playback application 114 to communicate with the first network service 112. The sharing device 110 can also include an extraction component 116 to extract metadata from media playback resources 111 received from the network service 112. In the latter example, the sharing device 110 can extract metadata from the locally stored files, and then transmit the metadata while playing back the locally stored media.

The sharing device 110 can communicate metadata 115 that corresponds to, or is based on, the extracted metadata provided with the media playback resources 111. In one implementation, the sharing device 110 and the receiving device 120 can communicate as peers using, for example, a wireless point-to-point connection. The point-to-point connection can be provided using, for example, a network medium such as Wi-Fi Direct or LTE Direct. The receiving device 120 can also include a media playback application 124 to communicate with the second network service 122. The receiving device 120 receives and stores the metadata 115 communicated from the sharing device 110.

According to one aspect, receiving device 120 includes a personalization filter 126 that determines one or more filters that are specific to the receiving device 120. By way of example, the personalization filter 126 can determine filters that are based on relevant activities of the user which indicate preference or taste of the user to, for example, music. As another example, the personalization filter 126 can determine filters that are based on the context in which the receiving device 120 operates, such as geographic location or area of the receiving device.

The receiving device 120 uses the filters to select metadata from which one or more search terms 127 or criteria are determined. The search term(s) 127 is communicated to the second network service 114, and the receiving device 120 receives media playback resources 121 from the second network service 122 which match the search term(s) 127. In one implementation, the first and second network services 112, 122 correspond to the same network service (e.g., SPOTIFY, PANDORA, BEATS MUSIC, GOOGLE PLAY). In a variation, the first and second network services 112, 122 are different. The search terms 127 can be communicated using the user's preferred network (e.g., local or home Wi-Fi). Additionally, the search terms 127 can be communicated asynchronously relative to when the metadata 115 is received. For example, the receiving device 120 may receive metadata as part of a background and/or application process when the user is in a coffee shop. The submission of the search terms 127, however, can be delayed until the user arrives home, at which time the user can use his or her preferred network connection to connect to the desired network service.

In a variation, system 100 includes one or more intermediate devices, shown as receive/transmit device 130 which serve to receive and forward metadata from a sharing device. The use of such intermediate devices can extend the range in which metadata 115 transmitted from a given sharing device 110 can be received by one or more receiving devices 120 using connection mediums such as Wi-Fi Direct and LTE. In an example of FIG. 1, the receive/transmit device 130 can operate to provide an additional hop for metadata 115 communicated from the source device 110 to the receiving device 120. By way of example, the sharing device 110 can broadcast metadata 115, and the receiving/transmit device 130 can include components to receive and transmit the metadata 115 to another device. In one implementation, the receiving/transmit device 130 includes a hop manager 132 that associates the metadata 115 with information that indicates the number of hops (e.g., devices operating as nodes) that separate the metadata 115 from the sharing device 110. The number of hops can provide a metric as to the quality or desirability of the metadata stream available from a particular device based on separation of that device with other devices that receive the broadcast data.

Sharing Device

FIG. 2 illustrates an example of a sharing device, according to an aspect. The sharing device 200 includes a metadata transmission system 210, a service interface 220 and a playback component 230. The service interface 220 links the sharing device 200 to a corresponding network service 212, such as provided by SPOTIFY, BEATS MUSIC, PANDORA or GOOGLE PLAY. The service interface 220 of the sharing device 200 receives media playback resources 201 from the corresponding network service 212. The playback component 230 of the sharing device 200 can output media using the media playback resources 201.

The metadata transmission system 210 extracts and communicates metadata associated with the media playback resources 201 to one or more devices over a local wireless connection, such as over a point-to-point connection provided by WiFi DIRECT or LTE Direct.

In one aspect, the metadata transmission system 210 includes a metadata extraction component 240, a filtering component 252, and metadata sharing component 260. The metadata extraction component 240 receives feed information 221 from the service interface 220. The feed information 221 includes metadata provided by the network service in connection with the media playback resources 201. The metadata extraction component 240 extracts metadata 241 from the feed information 221 of the network service 212 and stores the metadata 241 in a metadata store 245.

The filtering component 252 determines one or more filters 251 that are specific to the sharing device 20. For example, the one or more filters 251 can be specific to a preference of the user of the sharing device 20, or the context in which the sharing device 120 is being used (e.g., location or type of location where the device is being operated). The filtering component 252 can include a user preference component 254 that implements logic for determining one or more filters 251 that are based on signals 253 related to a user's past media consumption activities and/or known user preference. In a variation, the filtering component 252 can also include a location analysis component 256 that provides logic for determining one or more filters 251 that are based on signals 255 related to the operational environment (e.g., geographic location) of the sharing device 200.

The metadata sharing component 260 retrieves and broadcasts metadata sets 261 from the metadata store 245. In one variation, filters 251 are used to select, prioritize, or filter some metadata sets from other metadata sets stored in the metadata store 245. The retrieved metadata sets 261 can be used to generate a metadata transmission stream 265 that is communicated to one or more receiving devices using a point-to-point or direct communication link over a short range wireless medium (e.g., such as provided by Wi-Fi Direct or LTE Direct).

In one implementation, the metadata transmission system 210 also includes an expressions component 262. The expressions component 262 generates an expression for the metadata that characterizes one or more metadata sets or associated media playback resources. The expression component 262 can generate the expression 263 based on logic and/or user input. For example, the metadata of the media playback resource can identify a title and artist, while the expression generated for the metadata can correspond to a genre or characterization that a user of the sharing device 200 selects in order to convey a personalized characterization (e.g., meaning or sentiment of the user) of the media playback resource.

In one implementation, the metadata share component 260 broadcasts the expressions 263 along with the metadata transmission stream 265 to any device that is within range of its local wireless communication link. As described with other examples, other devices can receive the expressions 263, to enable users of such receiving devices to view characterizations of metadata sets included in metadata transmissions 265 of the sharing device 200.

In still another variation, the metadata transmission system 200 can include a listener 264 which receives intents 269 from other peer devices. As described with one implementation of FIG. 3, the intents 269 can be generated from receiving devices 300 (FIG. 3) which broadcasts tags identifying media playback resources that are of interest to that user. The metadata share component 260 can use the intents 269 in order to select metadata sets for the metadata feed 265.

Receiving Device

FIG. 3 illustrates an example of a receiving device, according to an aspect. In FIG. 3, a receiving device 300 includes a metadata reception system 310, a service interface 320, and a playback component 330. The metadata reception system 310 includes a retrieval component 330, a filtering component 352, and a metadata receiver 360. In one implementation, metadata receiver 360 receives the metadata broadcast streams 365 from one or more of the sharing devices 200 (e.g., see FIG. 2). The individual metadata stream 365 can also be provided with expressions 363 that characterize the respective metadata streams. Metadata sets provided with the metadata streams, as well as expressions 363, can be stored in the metadata store 345.

As described with other examples, the filtering component 352 of the receiving device 300 includes a user preference component 354 determines one or more filters 351 based on signals 353 related to a user's past media consumption activities. The user's past media consumption activities can be selected and/or weighted based on deemed relevance to the current preference or taste of the user. In a variation, the filtering component 352 can also include the location analysis component 356 that determines one or more filters 351 that are based on signals 355 related to the operational environment (e.g., geographic location) of the sharing device 200 (see FIG. 2). The filtering component 352 applies the filters 351 to the metadata store 345, in order to filter metadata from the metadata store 345. In one application, the filters 351 can reduce or eliminate data from select metadata streams 365 stored in the metadata store 345. In variations, the filtering component 352 can use the filters 351 to prioritize metadata stored in the metadata store 345.

Depending on implementation, the receiving device 300 can receive and personalize metadata streams 365 in a variety of ways. In one implementation, for example, the receiving device 300 receives metadata streams 365 for multiple sharing devices 200 (see FIG. 2) that are in sufficient proximity to the receiving device when the sharing device is using an access point provided at a public venue (e.g., restaurant, coffee shop). The filtering component 352 of the receiving device 300 can apply one or more filters 351 to stored metadata obtained from incoming metadata feeds 365 in order to identify preferred metadata sets. The application of the filters 351 can include eliminating unwanted metadata sets, and/or prioritizing preferred metadata sets based on filters 351 that incorporate personalization and/or contextual signals.

In still another variation, metadata sets 377 and/or expressions 363 can be made retrieved from the metadata store 345 and made viewable to the user through a user interface 382. The expressions 363 can, for example, be displayed on the user interface 382 as a channel. The metadata store 345 can store metadata sets 377 originating from the metadata streams of multiple devices, and the user-interface 382 can display expressions 363 from the individual devices. The user can use the expressions 363 to select metadata sets 377 from the incoming metadata streams 365.

As still another variation, receiving device 300 can broadcast intents 369 via the metadata sharing component (not shown in FIG. 3). In one implementation, the intents 369 are programmatically determined based in part on the determination of personalization output such as provided by the filtering component 352. For example, the filtering component 352 can generate intents 369 programmatically using input that correlates to past user media consumption activities and/or contextual information. In a variation, the intents 369 can be determined in part from user input. For example, the user can specify tags or other identifiers that are indicative of media playback resources that are of interest to the user.

According to one example, the intents 369 can include identifiers of metadata sets which are deemed to be of interest to a user of the receiving device 300. When a given sharing device receives the intents 369, a logical process can be implemented on, for example, the sharing device to determine whether the metadata streams 365 are a match for the intents 369. Once the intents 369 of the receiving device 300 are deemed to match, the sharing device 200, for example, can initiate a response to the receiving device 300. In one implementation, the receiving device 300 can then establish the connection with the sharing device in order to receive the metadata feed 365.

The retrieval component 330 accesses filtered metadata from the metadata store 345. In particular, the retrieval component 330 accesses metadata from the metadata store 345 after application of one or more filters 351. In this way, the retrieval component 330 can use filtered metadata sets in order to determine a search term 387 that is specific to a preference or context of the user and/or device. The search term 387 can, for example, identify a title (e.g., song), artist, playlist or other identifier for one or more media playback resources. The retrieval component 330 can use the service interface 320 to query a corresponding network service. The query can be communicated at any time, including asynchronously (e.g., hours or days after the corresponding metadata is received). The search term 387 returns media playback resources 389 which match or otherwise satisfy the search term 387. The media playback resources 389 can be played back using the playback component 330.

According to one implementation, the receiver device 300 selects the peer devices from which it receives metadata transmissions 365. In one aspect, the selection process can be based on metrics such as proximity or quality of the wireless transmissions. For example, in a crowded setting, multiple devices can transmit metadata streams 365 at one time, and the ability of the receiving device 300 to be selective facilitates the device in receiving transmissions from those devices that have better wireless connections with the receiving device. In one implementation, a peer selection component 366 operates to analyze data received from multiple devices which broadcast the metadata. In particular, examples recognize that some point-to-point wireless communication mediums such as LTE Direct provide metrics as to signal strength and quality of a transmission from a particular source.

Examples described herein further provide that individual devices can act as either the sharing device 200 or receiving device 300. For example, a given mobile computing device can include functionality for enabling that device to act as both a sharing and receiving device 200, 300. In each role, the operation of that particular computing device can be in accordance with one or more examples described herein for the respective sharing and/or receiving device.

Multi-Hop Device

FIG. 4 illustrates an example of a metadata receiving and sharing device (“MRS device 400”). The MRS device 400 can correspond to a device that relays or forwards sets of metadata transmitted from a given sharing device to a device operating as a receiving device. In one example, the MRS device 400 can operate to forward metadata sets originating from the sharing device 200 to the receiving device 300. Additionally, the MRS device 400 can operate to forward metadata sets originating from the sharing device 200 and communicated to the MRS device 400 via one or more intermediate devices. Still further, the MRS device 400 can operate to forward metadata sets originating from the sharing device to another device that is either the receiving device or another intermediate device.

In more detail, MRS device 400 includes metadata receiving and sharing system 410 (“MRS system 410”), service interface 420, and playback component 430. The MRS device 400 can include functionality such as described with sharing device 200 in an example of FIG. 2, as well as with receiving device 300 in an example of FIG. 3. In one implementation, the MRS system 410 includes a retrieval component 480, a user interface 482, a filtering component 452, a metadata sharing component 470, and a metadata receiving component 460. In an example of FIG. 4, the MRS device 400 acts as an intermediate device (see device 130 of FIG. 1) for forwarding metadata sets transmitted from the sharing device 200 to the receiving device 300. Accordingly, the MRS system 410 operates to (i) receive incoming metadata feeds 465 from a given sharing device (e.g., see sharing device 200 of FIG. 2) using metadata receiving component 460, and to (ii) communicate some of the metadata to one or more other devices (which can be other intermediate devices or the receiving device) using metadata sharing component 470.

In an example of FIG. 4, the metadata feed 465 can be stored in the metadata store 445. The metadata store 445 can also store metadata extracted from media playback resources received through a corresponding network service (not shown in FIG. 4). The filtering component 452 applies one or more filters 451 to the metadata store 445. The retrieval component 480 can generate, either responsively or asynchronously, one or more search requests 487 based on the filtered metadata 477. The network service can use the search request 487 to return one or more media playback resources 489 that can be outputted on the media playback component 430.

Further, as with an example of FIG. 3, the user interface 482 can display metadata sets 477 identified from metadata streams 465 shared by other users. The metadata sets 477 can optionally result from the application of the filter 451 on the metadata stream 465, when stored in the metadata store 445. In some variations, the displayed metadata can include one or more expressions 479, which can be derived from share metadata sets.

In an example of FIG. 4, the MRS system 410 operations to manage the number of hops that take place before a transmitted metadata set from a sharing device is used. In one implementation, a hop counter 464 increments a counter 475 associated with an incoming metadata set. For example, if the incoming metadata set is communicated directly from the sharing device 200 (see FIG. 2), the counter 475 can be increments from “0” to “1”, indicating that the particular metadata set has only hopped once. The incoming metadata set can be stored in the metadata store 445, and used on the MRS device 400 in order to, for example, generate search request 487. As an addition or alternative, the incoming metadata set can be communicated to another device via a direct wireless connection. When communicated to another device, the incremented counter is also transmitted with the metadata set. Likewise, if the MRS device 400 receives another incoming metadata set that is communicated from another device that (along with zero or more other devices) intercepted the metadata set communicated from the source device 200, then the counter associated with incoming metadata set indicates the number of hops from the source device to the current device. Thus, for example, the hop counter 464 would increment the counter 475 from “n” (where n>1) to “n+1”.

In one example, the metadata store 445 stores a metadata set along with the counter 475, and the MRS system 410 includes logic to ensure that the metadata set is fresh. In particular, hop filter 468 can apply an additional filter 467 that eliminates or lessens the priority of metadata sets which have their respective hop counters 475 exceed a threshold. Such metadata sets can be assumed to originate from source devices 200 that are multiple hops away from the current device. In this respect, the metadata sets may be deemed less fresh, as originating from a device that is spatially distant from the current device. Additionally, the extracted metadata sets with the high hop counters may have been shared at a time that is now considered stale, based on a time threshold (e.g., more than 1 hour). For metadata sets that have counters that exceed the threshold, the hop filter 468 can apply the filter 467 to eliminate and/or lessen the priority of such metadata sets. The effect can be that the MRS device 400 itself, such as through retrieval component 480 and/or user interface 482, does not utilize the metadata sets which have counters 475 that exceed the threshold. Still further, the device may avoid re-transmitting metadata sets that have counters 475 which exceed a given threshold, but may rather delete such metadata sets from the metadata store 445 without taking any further action on those data sets.

Filtering Component

FIG. 5 illustrates an example of a filtering component. A filtering component 500 can be implemented with, for example, source device 200 (see filtering component 252), receiving device 300 (see filtering component 352) and/or MRS device 400 (see filtering component 452). According to one aspect, the filtering component 500 utilizes components that can determine filters based on user activity (e.g., music consumption activities) and preferences, as well as on a context of the operation of the computing device.

In more detail, filtering component 500 can include filtering logic 550, and one or more of (i) a playback monitor 510, (ii) a request monitor 520, (iii) a favorites/likes monitor 530, (iv) a context logic 540, (v) a library analysis component 560, and/or (vi) a media feed analysis component 570.

The playback monitor 510 detects playback input signals 511 corresponding to what media resources the user played back (e.g., in a given time period). By way of example, the playback monitor 510 can (i) detect locally stored music that is played back on the computing device, (ii) remotely stored music that is locally played back on the computing device, and/or (iii) streaming music items played back on the computing device. The playback monitor 510 can generate a playback signal 513, which can include or correlate to, for example, a track or title of a song that the user played back, as well as other identifying information such as an artist, album or playlist.

The request monitor 520 can detect request input 521 in order to generate request signal 523 as output. The request input 521 can correspond to music or media that the user requested for playback from an external source. Thus, for example, the user's request from a network service can serve as a request input 521. Examples recognize that the request input 521 does not always equate to the musical item that was played back. For example, a musical service can accept search terms from a user that correspond to a particular song, but the network service may use the search term for the requested song to output at least one different song that is of the same genre as that of the specified search term.

The favorites/likes monitor 530 can identify playlists, song titles, artists and/or albums which the user has provided favorite/like input 531. The favorite/like input 531 can correspond to, for example, a binary input that indicates that the user liked a particular song, title, playlists or output. As an alternative to the binary input, the favorite/like input 531 can correspond to a rating (e.g., five out of five stars). Still further the favorite/like input 531 can correspond to playlist of favorite items. An output of the favorite/likes monitor 530 can include a favorite/like signal 533.

The context logic 540 can determine, for example, contextual information 543 based on one or more types of contacts input 541. By way of example, the context input 541 can relate to the geography of the computing device at a particular time. As an alternative or variation, the contextual logic 540 can utilize other parameters, such as time, the type of network connection, or information determined from environmental settings (e.g., amount of ambient light, amount of environmental noise) in order to determine contextual information relevant to the output of music and other media from the particular computing device. In one example, the context logic 540 includes a geographic component 542 that can determine a location of the computing device at a particular moment, and the location can then be correlated to, for example, a setting such as a public venue (e.g., coffee shop, concert, restaurant etc.). To further the example, the particular venue can be deemed as the contextual information, since the type of media that a user may wish to playback can be based on venue (e.g., the type of music a user may wish to playback at a coffee shop can be different than music the user wishes to listen to in a restaurant). The geographic component 542 can be based on, for example, a global positioning system (GPS) resource. However in variations, the geographic component 542 can include logic that determines the location of the computing device based on other parameters, such as the information determined from the network connection (e.g., an identifier associated with a Hot Spot). One or more other component 544 of the contextual logic 540 can include, for example, a timing component that determines the time of day, and/or one or more sensors that determine environmental conditions.

The library analysis component 560 can use library input 561 in order to determine a library signal 563. The library can correspond to collection a media, such as downloaded songs that are resident on the computing device or network provided resources that are associated with the company device.

The media feed analysis component 570 can receive media input 571 in order to generate a media feed signal 573. The media feed signal 571 can correspond to, for example, streaming media that the computing devices receive at a particular moment when filtering occurs. Such input can be indicative of the user's preference or taste, particularly of the moment of time or in regard to other context (e.g. such as location).

The filtering logic 550 can generate one or more filters 582 using signals from one or more components such as described with an example of filtering component 500. In some implementations, the signals from the various components can be weighted by the filtering logic 550 in generating the filters 582. The implemented weights can be based on various factors, such as system and user settings.

Methodology

FIG. 6 illustrates an example method for sharing metadata related to the media playback resources. FIG. 7 illustrates an example method for receiving metadata from other peer devices and using the metadata to discover media playback resources. FIG. 8 illustrates an example method for receiving metadata from other peer devices, and for forwarding received metadata to other devices for use. Example methods such as provided with FIG. 6, FIG. 7 and FIG. 8 can be implemented using a system such as shown with an example of FIG. 1. Additionally, an example method such as provided by FIG. 6 can be implemented using a source device such as shown with an example of FIG. 2. Similarly, an example method such as provided by FIG. 7 can be implemented using a receiving device such as shown with an example of FIG. 3. Still further, an example method such as provided by FIG. 8 can be implemented using a metadata receiving and transmission device such as shown with an example of FIG. 4. Accordingly, reference may be made to elements of other figures for purpose of illustrating suitable components for performing a step or sub-step being described.

With reference to FIG. 6, the computing device extracts metadata from a streaming media feed (e.g., media playback resources, such as streaming song titles) (610). For example, source device 200 may connect with network service 212 in order to receive media playback resources 201. The metadata that is extracted can correspond to, for example, the title or name of the song, name of the artist, the playlists or album associated with the track, the predetermined genre category identifier of the title, the rating for the title, and/or other information.

In one variation, sharing device 200 aggregates metadata from one or more network services 212 (620). The aggregated metadata can be stored as metadata sets in the memory of the sharing device 200. The metadata sets can be individually associated with the particular track or media playback resource.

A personalization filter can be provided to the aggregated metadata (630). In one implementation, the personalization filter can be determined using logic such as shown by an example of FIG. 5. In one implementation, the personalization filter can be applied in order to select or prioritize which metadata sets will be shared or otherwise transmitted to other peer devices. As an addition or variation, the personalization filter can be applied in order to determine what metadata sets are used on this particular sharing device.

According to one aspect, the personalization filter can include one or more filters that are based on past user activity, which may indicate the preference or taste of the user for media playback resources (632). By way of example, the personalization filter can be based on media playback resources which the user has stored, played back, liked, favorited, or requested.

As an alternative or variation, the apply filter can be based on contextual information (634). The contextual information can be determined from a variety of sources, such as from (i) the location of the computing device that is applying the filter (e.g., using it GPS component), (ii) information provided with a connected Wi-Fi Hot Spot, (iii) the number of devices that are sharing or receiving metadata, or which are in the vicinity of the particular device, and/or (iv) the type of venue (e.g., whether the user is in a restaurant or coffee shop).

As an addition or variation, the sharing device 200 can further implement one or more processes in order to determine expressions for aggregated metadata (636). In one implementation, the process is implemented to prompt the user for input that identifies an expression related to the particular media playback resource. In this way, the user can provide an expression that characterizes the particular media playback resource in a manner that is personalized (e.g., with sentiment). In a variation, the process to generate expressions is performed autonomously, and or programmatically. For example, metadata sets stored in the metadata store 245 of the sharing device 200 can be analyzed by a separate logical component in order to identify categories, such as personalized genres and subgenres. Such categorical identification can be based on, for example, (i) the artist or the pre-defined genre provided by the network service 212, and/or (ii) activity of the user (e.g., most favorite song, most favorite artist, song played most often at coffee shop etc.). The determined expressions can then include or correspond to the newly determined genres.

The metadata sets can be shared with other peer devices (640). In one implementation, the sharing device 200 broadcasts the metadata sets for any device that is listening, and those receiving devices store and filter the metadata sets using their own respective personalization filters. In a variation, the sharing device 200 broadcasts expressions of the metadata sets (642), and enables other receiving devices to connect to the sharing device 200 in order to receive the metadata sets that correspond to the expressions. Still further, the receiving device 200 can pick up intents from other receiving devices. The sharing device 200 can include logic which matches incoming intents with select metadata sets, and then transmits the select metadata sets to those receiving devices that transmitted the intents.

With reference to FIG. 7, receiving device 300 operates to select a peer device over a wireless medium (710). The selection of the peer device can be based on a variety of factors. In particular one implementation provides for the receiving device 300 to select the peer device based on one or more characteristics of the wireless connection (712). For example, the signal strength or quality of the wireless connection (e.g., using Wi-Fi Direct or LTE Direct) can be analyzed in order to determine, from the receiving device, those peer devices which have the best wireless connection for transmitting the metadata feeds.

As an alternative or variation, the selection of the peer device can be based on metadata broadcast (714), as described by some examples detailed below.

The receiving device can determine a personalization filter for personalizing metadata stored or used on the receiving device (720). In one implementation, the filtering component 352 of the receiving device 300 can determine one or more preferences based on past user media consumption activities that indicate a user's taste or preference for media playback resources (722). As an alternative or variation, the filtering component 352 can determine contextual information that indicates context parameters, such as those based on location, time, or venue (724).

In addition to determining personalization filters, the receiving device 300 can aggregate metadata that includes or corresponds to metadata sets (730). In one implementation, the receiving device 300 receives expressions (e.g., personalized categories or genres of a sharing device) (732), corresponding to characterizations or summaries of metadata tags provided by a given sharing device. The expressions can be stored and displayed to the user and enable user selection of devices based on metadata sets represented by selected expressions.

Still further, as another variation, the peer device can broadcast intents (734), corresponding to tags or other identifiers for media playback resources that are of interest to the receiving device. The determination of the intents can be based on programmatically determined personalization parameters and/or user input. The intents can be broadcast to sharing devices 200, which in turn respond and connect with the receiving device 300.

In one variation, the receiving device 300 can aggregate metadata set transmissions from multiple devices, continuously and/or without discrimination, and then use personalization filters (e.g., as determined with an example of FIG. 5) to select metadata sets for use (736). In such an example, the receive metadata sets can be stored locally and filtered based on personalization parameters and contextual information. The determined personalization filters can be used to filter metadata sets received from multiple devices.

In one aspect, the user can search or otherwise discover media playback resources using metadata sets that are determined after aggregated metadata is filtered (740). In one implementation, personalize metadata sets are used to determine the search term on the receiving device 300. The search term can then be used to identify one or more media playback resources on a corresponding network service via a media component and/or service interface.

With reference to FIG. 8, the MRS device 400 receives metadata that is shared from another device (810). As described with various examples, the MRS device 400 can perform one or more of (i) store the metadata, (ii) determine one or more personalization parameters for the metadata, (iii) use the metadata to identify media playback resources, (iv) determine one or more search parameters of discovery options based on the receive metadata, and/or (v) forward the metadata to one or more other peer devices.

In one implementation, the MRS device increments a hop counter associated with an incoming metadata set (820). The incoming metadata set can be stored on the MRS device 400 for subsequent use (830).

Across the platform in which multiple peer devices are operating, the hop counter can reflect a number of hops that a given set of metadata has incurred since being transmitted from a source. The greater the counter, the more separation may exist between the ultimate receiving device and the source device. Thus, while using multiple hops to share metadata sets can expand the reach of the examples described herein, the inclusion the multiple hops can also yield metadata sets that are stale, or too separate from the source device to merit reception by a particular receiving device.

Accordingly, one implementation provides for filtering the metadata sets based on the hop counter (832). If the hop counter exceeds a given threshold, the MRS device 400 may filter that metadata set so that it is not used and/or not forwarded on to another peer device.

The MRS device 400 can use received metadata and also forward the received metadata onto other peer devices. In one implementation, receive metadata can be used to search and discover media playback resources on a given network service associated with the MRF device 400 (840). Still further, receive metadata can be subjected to a personalization filter, which delineates those metadata that the user is interested in from other metadata which the user has aggregated when operating to forward metadata sets to other peer devices (842).

The MRS device 400 can forward metadata sets to other peer devices in an implementation in which multiple hops connect to sharing device 200 with one or more receiving devices 300 (850). In one implementation, the forwarded metadata sets can be individually provided with a hop counter to designate the number of hops that have taken place since the metadata set was first transmitted from a respective sharing device 200.

Computer System

FIG. 9 is a block diagram that illustrates a computer system upon which embodiments described herein may be implemented. For example, in the context of FIG. 1 and FIG. 2 through FIG. 4, each of the sharing device 110, 200, receiving device 120, 300 or MRS device 130, 400 can be implemented using one or more computer systems such as described by FIG. 9. Still further, a filtering component such as described with an example of FIG. 5, as well as methods such as described with examples of FIG. 6, FIG. 7 and FIG. 8 can be implemented using a computer such as described with an example of FIG. 9.

In an example, computer system 900 includes processor 904, memory 906 (including non-transitory memory), storage device 910, and communication interface 918. Computer system 900 includes at least one processor 904 for processing information. Computer system 900 also includes a memory 906, such as a random access memory (RAM) or other dynamic storage device, for storing information and instructions to be executed by processor 904. The memory 906 also may be used for storing temporary variables or other intermediate information during execution of instructions to be executed by processor 904. Computer system 900 may also include a read only memory (ROM) or other static storage device for storing static information and instructions for processor 904. A storage device 910, such as a magnetic disk or optical disk, is provided for storing information and instructions. The communication interface 918 may enable the computer system 900 to communicate with one or more networks through use of the network link 920 (wireless or wireline).

In one implementation, memory 906 may store instructions for implementing functionality such as described with an example system of FIG. 1, computing devices such as described with examples of FIG. 2 through FIG. 4, filtering component such as described with an example of FIG. 5, or methods such as described with examples FIG. 6 through FIG. 8. Likewise, the processor 504 may execute the instructions in providing functionality as described with an example system of FIG. 1, computing devices such as described with examples of FIG. 2 through FIG. 4, filtering component such as described with an example of FIG. 5, or methods such as described with examples of FIG. 6 through FIG. 8.

Embodiments described herein are related to the use of computer system 900 for implementing the techniques described herein. According to one aspect, those techniques are performed by computer system 900 in response to processor 904 executing one or more sequences of one or more instructions contained in the memory 906. Such instructions may be read into memory 906 from another machine-readable medium, such as storage device 910. Execution of the sequences of instructions contained in memory 906 causes processor 904 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

1. A method for operating a computing device to use metadata in order to obtain a media playback resource, the method being implemented by one or more processors and comprising:
(a) receiving, from at least a first peer device, a set of metadata, the set of metadata including one or more identifiers to media playback resources;
(b) determining one or more filters for the set of metadata;
(c) selecting a metadata from the set of metadata based on the one or more filters; and
(d) sending a search request to a network service for a media playback resource based on the selected metadata.

2. The method of claim 1, wherein (a) includes receiving the set of metadata over a point-to-point connection with the first peer device.

3. The method of claim 1, wherein (a) includes receiving the set of metadata over a point-to-point connection while the first peer device receives a first streaming media resource corresponding to the selected metadata from a first network service.

4. The method of claim 3, wherein (d) includes sending the search request to a second network service, and wherein the method further comprises receiving a second streaming media resource corresponding to the selected metadata from the second network service.

5. The method of claim 1, wherein the method further comprises sharing metadata from the set of metadata with at least a second peer device across a point-to-point connection.

6. The method of claim 5, wherein sharing the metadata includes:
iterating a hop counter associated with each of the metadata that are received from the first peer device; and
removing or prioritizing use of the metadata that are received from the first peer device based at least in part on the hop counter.

7. The method of claim 1, wherein (b) includes analyzing user activity relating to media playback devices.

8. The method of claim 7, wherein the user activity includes one or more of (i) a media playback resource that a user of the computing device has played back, (ii) a media playback resource that the user of the computing device has requested from a network service, (iii) a playback resource that the user of the computing device has liked or favorited, (iv) a collection of media files that the user of the computing device has stored on a memory resource of the user.

9. The method of claim 1, wherein (b) includes determining contextual information relating to a current use of the computing device.

10. The method of claim 9, wherein the contextual information includes information about a location of the computing device at the current use.

11. A computing device comprising:
a memory that stores a set of instructions;
one or more processors that use the set of instructions to:
(a) receive, from at least a first peer device, a set of metadata, the set of metadata including one or more identifiers to media playback resources, the set of metadata being stored in the memory;
(b) determine one or more filters for the set of metadata;
(c) select a metadata from the set of metadata based on the one or more filters; and
(d) send a search request to a network service for a media playback resource based on the selected metadata.

12. The computing device of claim 11, wherein the one or more processors perform (a) by receiving the set of metadata over a point-to-point connection with the first peer device.

13. The computing device of claim 11, wherein the one or more processors perform (a) by receiving the set of metadata over a point-to-point connection while the first peer device receives a first streaming media resource corresponding to the selected metadata from a first network service.

14. The computing device of claim 13, wherein the one or more processors perform (d) by sending the search request to a second network service, and wherein the one or more processors use the set of instructions in order to receive a second streaming media resource corresponding to the selected metadata from the second network service.

15. The computing device of claim 11, wherein the one or more processors use instructions in the set of instructions to share metadata from the set of metadata with at least a second peer device across a point-to-point connection.

16. The computing device of claim 15, wherein the one or more processors share the metadata by:
iterating a hop counter associated with each of the metadata that are received from the first peer device; and
removing or prioritizing sharing or use of the metadata that is received from the first peer device based at least in part on the hop counter.

17. The computing device of claim 11, wherein the one or more processors perform (b) by analyzing user activity relating to media playback devices.

18. The computing device of claim 17, wherein the user activity includes one or more of (i) a media playback resource that a user of the computing device has played back, (ii) a media playback resource that the user of the computing device has requested from a network service, (iii) a playback resource that the user of the computing device has liked or favorited, (iv) a collection of media files that the user of the computing device has stored on a memory resource of the user.

19. The computing device of claim 11, wherein the one or more processors perform (b) by determining contextual information relating to a current use of the computing device.

20. The computing device of claim 19, wherein the contextual information includes information about a location of the computing device at the current use.

21. A non-transitory computer-readable medium that stores instructions that, when executed by one or more processors, cause a computing device of the one or more processors to perform operations comprising:
(a) receiving, from at least a first peer device, a set of metadata, the set of metadata including one or more identifiers to media playback resources;
(b) determining one or more filters for the set of metadata;
(c) selecting a metadata from the set of metadata based on the one or more filters; and
(d) sending a search request to a network service for a media playback resource based on the selected metadata.

22. A computer system comprising:
a first device that operates to:
receive a media playback resource from a first network service;
extract metadata, including a first set of metadata, from the media playback resource; and
broadcast data corresponding to the first set of metadata;
a second device that operates to:
aggregate metadata from a plurality of sources, including metadata from the first set of metadata;
determine one or more filters;
select metadata from the aggregated metadata based on the one or more filters; and
send a search request to one of the first network service or a second network service.

23. The system of claim 22, wherein the first device operates to determine one or more expressions from the first set of metadata, and wherein the data broadcast from the first device includes the one or more expressions.

24. The system of claim 23, wherein the second device receives the one or more expressions from the first device, and displays the one or more expressions in order to enable a user to select to receive the first set of metadata.

25. The system of claim 22, further comprising a third device that operates to:
receive the first set of metadata; and
forward the first set of metadata to the second device.

26. The system of claim 25, wherein the third device operates to determine if the first set of metadata satisfies a threshold for forwarding, the threshold being based at least in part on a number of devices that previously received the first set of metadata originating from the first device.

27. The system of claim 22, wherein the second device operates to send the search request to the network service while the first device receives the media playback resource from the first network service.

28. The system of claim 22, further comprising a third device that operates to:
receive the first set of metadata;
forward the first set of metadata to the second device; and
wherein the second device operates to send the search request to the network service while the first device receives the media playback resource from the first network service.

29. The computer system of claim 22, wherein the first device operates to:
determine one or more filters based on one or more of user-activity or contextual information that is specific to the first device; and
wherein the first device selects the first set of metadata based at least in part on the determined one or more filters.

30. The computer system of claim 29, wherein the second device operates to:
determine one or more filters based on one or more of user-activity or contextual information that is specific to the second device; and
wherein the second device selects to receive the first set of metadata based at least in part on the determined one or more filters.
